(19) United States
(12) Patent Application Publication
(10) Pub. No.: US 2024/0283758 A1
(43) Pub. Date: Aug. 22, 2024

(54) DIALOGUE APPARATUS, DIALOGUE METHOD AND PROGRAM

(71) Applicant: NIPPON TELEGRAPH AND TELEPHONE CORPORATION, Tokyo (JP)

(72) Inventors: Atsushi OTSUKA, Tokyo (JP); Narichika NOMOTO, Tokyo (JP); Shiro OZAWA, Tokyo (JP)

(21) Appl. No.: 18/568,558

(22) PCT Filed: Jul. 12, 2021
(86) PCT No.: PCT/JP2021/026108

§ 371 Date: Dec. 8, 2023

(51) Int. Cl. H04L 51/02

(52) U.S. Cl. CPC H04L 51/02

(57) ABSTRACT

A dialogue device includes: an initial utterance generation unit that generates first utterance information serving as a trigger for a dialogue with a user; a general-purpose dialogue generation unit that generates second utterance information; and a dialogue control unit that controls the dialogue with the user, based on the first utterance information or the second utterance information.

### TECHNICAL FIELD

The present invention relates to a dialogue device, a dialogue method, and a program.

### BACKGROUND ART

In recent years, various methods have been suggested as methods to be applied to devices with which a human and a machine have a conversation, or devices that generate responses to questions. For example, a method using deep learning for a dialogue such as a chat (Patent Literature 1), and a method for performing a dialogue in accordance with a dialogue scenario (Patent Literature 2), and the like have been disclosed.

In recent years, there is a dialogue device that has an object of imitating dialogues of a certain character (Non-Patent Literature 1). This device collects training data, which has been an issue with implementation of a dialogue device, by collecting questions and responses of a certain character having social recognition, the questions and responses being created by a large number of participants “completely pretending to be the character”.

### CITATION LIST

### Patent Literature

Patent Literature 1: JP 2018-147189 A

Patent Literature 2: JP 2019-159489 A

### Non-Patent Literature

Non-Patent Literature 1: Ryuichiro Higashinaka, et al. “Using Role Play for Collecting Question-Answer Pairs for Dialogue Agents”, INTERSPEECH 2013, pp. 1097-1100, [online], Internet <URL:https://www. isca-speech.org/archive/archive_papers/interspeech_2013/i13_1097.pdf>

### SUMMARY OF INVENTION

### Technical Problem

However, while characters in the conventional technologies are given certain features, individuals may not necessarily have such features. Furthermore, it is basically difficult to completely pretend to be an individual to be learned, and it is considered that only several people around the individual can create data for completely pretending to be the individual. As such, by the conventional technologies, it is difficult to implement a data collection mechanism for learning responses of a specific individual, and therefore, there has been an issue that implementation of dialogues specialized for a specific individual is difficult.

The technology disclosed herein aims to implement dialogues specialized for a specific individual.

### Solution to Problem

The technology disclosed herein relates to a dialogue device that includes: an initial utterance generation unit that generates first utterance information serving as a trigger for a dialogue with a user; a general-purpose dialogue generation unit that generates second utterance information; and a dialogue control unit that controls the dialogue with the user, based on the first utterance information or the second utterance information.

### Advantageous Effects of Invention

Dialogues specialized for a specific individual can be implemented.

### BRIEF DESCRIPTION OF DRAWINGS

FIG. 1 is a diagram illustrating an example system configuration of a dialogue system.

FIG. 2 is a diagram illustrating an example functional configuration of a dialogue device.

FIG. 3 is a table illustrating an example of initial utterance information.

FIG. 4 is a flowchart illustrating an example flow of a dialogue process.

FIG. 5 is a flowchart illustrating an example flow of a learning process.

FIG. 6 is a chart showing a specific example of a dialogue before learning.

FIG. 7 is a chart showing a specific example of a dialogue after learning.

FIG. 8 is a diagram illustrating an example hardware configuration of a computer.

### DESCRIPTION OF EMBODIMENTS

In the following, an embodiment of the present invention (the present embodiment) will be described with reference to the drawings. The embodiment described below is merely an example, and embodiments to which the present invention is to be applied are not limited to the embodiment described below.

### (Outline of the Present Embodiment)

A dialogue device according to the present embodiment controls a dialogue with a user via a chat system based on a dialogue model and initial utterance information. The dialogue device then generates training data from a history of dialogues with the user, and updates model parameters of the dialogue model by machine learning.

### (Example System Configuration of a Dialogue System)

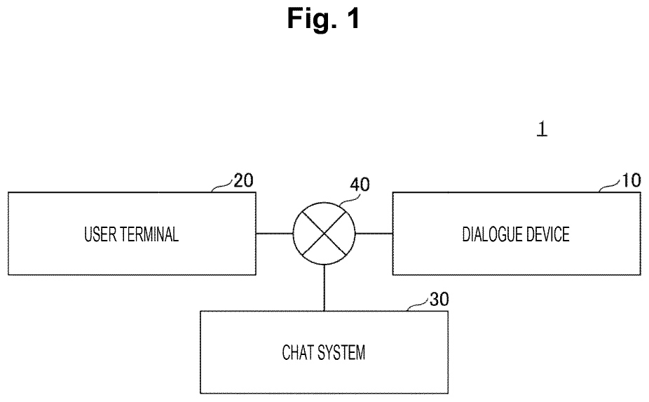

FIG. 1 is a diagram illustrating an example system configuration of a dialogue system. A dialogue system 1 includes a dialogue device 10, a user terminal 20, and a chat system 30.

The dialogue device 10 is connected to the user terminal 20 and the chat system 30 via a communication network 40 so as to be capable of communicating with each other. The dialogue device 10 controls the chat system 30 to control an online chat being performed between the user terminal 20 and the chat system 30. Specifically, the dialogue device 10 transmits data indicating contents of the dialogue with the user to the chat system 30, so as to function as a chatbot in the online chat.

The dialogue device 10 then generates training data from the history of dialogues with the user, and updates the model parameters of the dialogue model by machine learning.

The user terminal 20 is a terminal that receives operations of the user, and performs transmission/reception of dialogue data to/from the chat system 30.

The chat system 30 is a system, for example, that executes an online chat such as an SNS with a plurality of terminals. The chat system 30 implements a dialogue between the dialogue device 10 functioning as a chatbot and the user terminal 20. Specifically, data indicating an utterance from the chatbot transmitted from the dialogue device 10 is transmitted to the user terminal 20, and is displayed on the user terminal 20. Also, data that is transmitted from the user terminal 20 and indicates an utterance from the user is transmitted to the dialogue device 10.

### (Example Functional Configuration of a Dialogue Device)

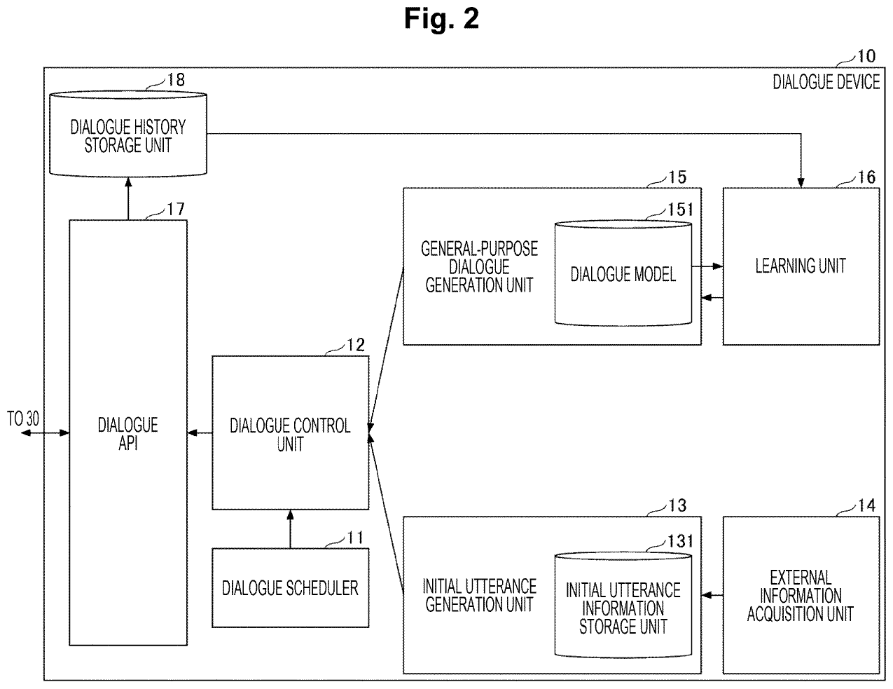

FIG. 2 is a diagram illustrating an example functional configuration of a dialogue device. The dialogue device 10 includes a dialogue scheduler 11, a dialogue control unit 12, an initial utterance generation unit 13, an external information acquisition unit 14, a general-purpose dialogue generation unit 15, a learning unit 16, a dialogue application programming interface (API) 17, and a dialogue history storage unit 18.

The dialogue scheduler 11 controls a schedule of dialogues. For example, at a fixed time every day, the dialogue scheduler 11 transmits a notification to the dialogue control unit 12 so as to start a dialogue with the user.

The dialogue control unit 12 controls utterances as a chatbot. Specifically, based on a certain rule, the dialogue control unit 12 chooses whether to cause the initial utterance generation unit 13 to generate utterance information (hereinafter referred to as the first utterance information), or to cause the general-purpose dialogue generation unit 15 to generate utterance information (hereinafter referred to as the second utterance information). The certain rule is a rule to cause the initial utterance generation unit 13 to generate the first utterance information in a case where a predetermined initial utterance condition is satisfied, for example. The initial utterance condition is the condition that an utterance is initiated by the dialogue scheduler 11, for example.

Further, the certain rule may include other rules, and, for example, a condition that dialogue information on a magic word such as “initial utterance request” is received from the user terminal 20 may also be included in the initial utterance condition. Note that this magic word may be set at the user's discretion.

Furthermore, a condition that a continued dialogue using the general-purpose dialogue generation unit 15 exceeds a preset number of turns T may also be included in the initial utterance condition. In this case, in a case where the initial utterance condition is satisfied, the dialogue control unit 12 resets the number of turns T to 0. Note that the number of turns T may be set at the user's discretion, or may be a fixed value.

The initial utterance generation unit 13 generates the first utterance information such as a question asking about the user's personality that serves as a trigger for a dialogue with the user. The initial utterance generation unit 13 includes an initial utterance information storage unit 131, selects one scenario from among the initial utterance information stored in the initial utterance information storage unit 131, and generates the first utterance information based on the selected scenario. Specific examples of the initial utterance information will be described later.

In a case where the scenario selected from among the initial utterance information requires external information, the external information acquisition unit 14 acquires the external information by communicating with an external server device or the like via the communication network 40 or the like. The external information is preferably real-time information such as the latest news information or weather information, for example.

The general-purpose dialogue generation unit 15 generates the second utterance information for a general-purpose dialogue different from the initial utterance information. Specifically, the general-purpose dialogue generation unit 15 includes a dialogue model 151, and generates the second utterance information using the dialogue model 151.

The dialogue model 151 is initially a dialogue model trained by general-purpose machine learning, and is preferably a general-purpose dialogue model not trained through data such as a specific user or character, but trained using a large amount of training data. The model parameters of the dialogue model 151 are then updated through machine learning performed by the learning unit 16 as will be described later, and the dialogue model turns into a dialogue model specialized for dialogues with a specific user.

The learning unit 16 generates training data based on a history of dialogues with the specific user stored in the dialogue history storage unit 18, and updates the model parameters of the dialogue model 151 by machine learning based on the generated training data. The learning unit 16 may train the dialogue model 151 in a generalized state that has been trained using a large amount of training data, or may further re-train the dialogue model 151 that has progressed in training to a certain extent.

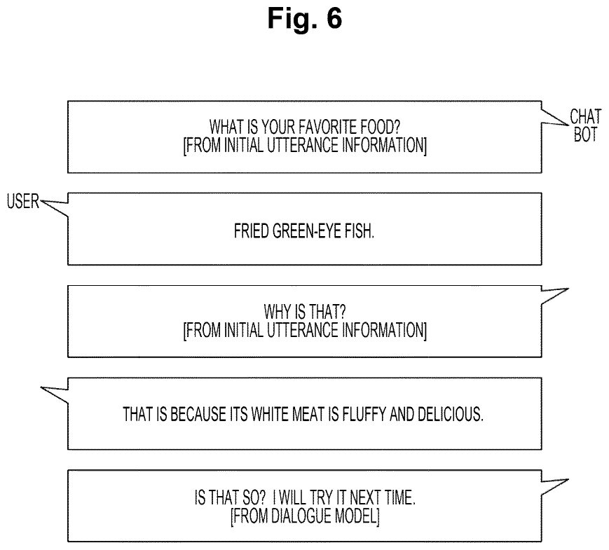

The learning unit 16 generates training data based on the contents of utterances of the user. For example, the learning unit 16 generates training data, using training data that is data such as “It is fried green-eye fish” and “That is because their white meat is fluffy and delicious”, which are utterances of the user, based on the dialogue history illustrated in FIG. 6, for example.

As the learning unit 16 executes learning by using the user's utterances as the training data, the dialogue model 151 is expected to generate utterances close to the user's liking, preferences, and the like, and turn into a dialogue model specialized for dialogues with the user.

The dialogue API 17 is an API that performs the process for connecting to the chat system 30. For example, the dialogue API 17 may be a general-purpose library such as Hubot (registered trademark). The dialogue API 17 stores history information on dialogues between the user and the chatbot into the dialogue history storage unit 18. The data format of the history information is a text format, for example. A specific data collection method, collection frequency, and the like may be set as desired by the user.

The dialogue history storage unit 18 stores the history information on dialogues between the user and the chatbot. Note that the history information stored in the dialogue history storage unit 18 includes only the dialogues with the specific user.

Note that the dialogue device 10 may be capable of handling dialogues with a plurality of users. In that case, the general-purpose dialogue generation unit 15 has a plurality of dialogue models 151, and uses a dedicated dialogue model 151 for each user. The dialogue history storage unit 18 then stores history information allocated to the respective users. The learning unit 16 performs machine learning for each user. Thus, even in a case where dialogues with a plurality of users are handled, machine learning specialized for each user can be performed.

### (Specific Example of the Information to Be Handled by the Dialogue Device)

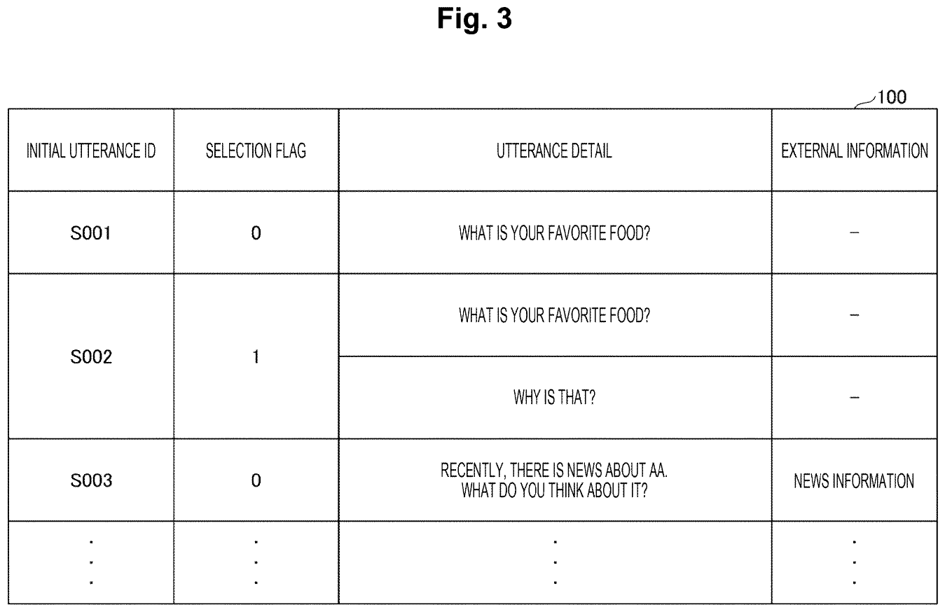

FIG. 3 is a table illustrating an example of the initial utterance information. Initial utterance information 100 includes items that are initial utterance ID, selection flag, utterance contents, and external information.

The values in the item “initial utterance ID” are identifiers for identifying the respective scenarios in the initial utterance information.

The values in the item “selection flag” are flags each indicating whether it is selected for a dialogue with the user. The initial utterance generation unit 13 does not select the scenario for which the selection flag is set for a certain period of time. After the certain period of time has elapsed since the selection, the initial utterance generation unit 13 resets the selection flag, and makes it selectable again.

The values in the item “utterance details” are values indicating the contents of utterances. Note that each scenario may include a plurality of utterances. In that case, the initial utterance generation unit 13 selects utterance contents according to a determined scenario as a response to an utterance from the user. Specifically, a scenario including a plurality of utterances may be a scenario in which determined utterance contents are to be sequentially selected regardless of a response from the user, or may be a scenario in which utterance contents divided in accordance with a response from the user are set, for example.

For example, the scenario S002 shown in FIG. 3 is a scenario in which, in a case where there is a response from the user to an utterance “What is your favorite food?”, an utterance “Why is that?” is to be returned regardless of the response from the user.

The value in the item “external information” is a value indicating what kind of external information is needed in a case where external information is required. In the case of the first utterance information in which this value is set, the initial utterance generation unit 13 generates the first utterance information by embedding the external information acquired by the external information acquisition unit 14 in the first utterance information.

For example, the scenario S003 shown in FIG. 3 is a scenario in which an utterance is to be made, with new information acquired by the external information acquisition unit 14 being embedded in the “AA” portion of the first utterance information, which reads “Recently, there is news about AA. What do you think about it?”.

### (Example Operations of the Dialogue Device)

Next, operations of the dialogue device 10 will be described. The dialogue device 10 starts a dialogue process with the dialogue scheduler 11, or by receiving dialogue information from the user terminal 20.

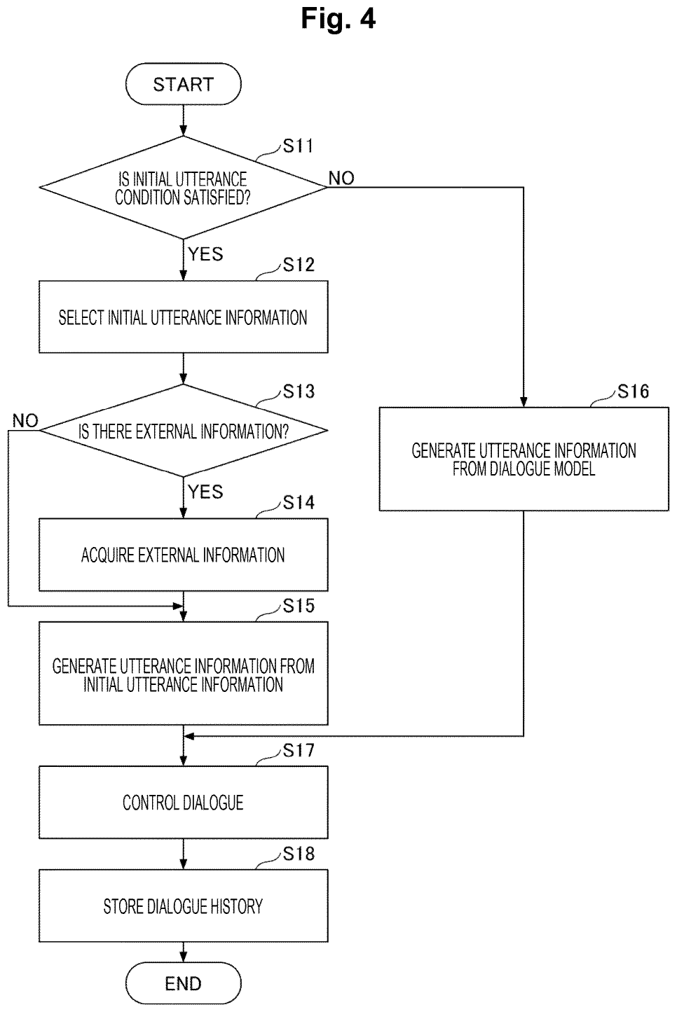

FIG. 4 is a flowchart illustrating an example flow of a dialogue process. The dialogue control unit 12 determines whether the initial utterance condition is satisfied (step S11). If the dialogue control unit 12 determines that the initial utterance condition is satisfied (step S11: YES), the initial utterance generation unit 13 selects initial utterance information (step S12).

Next, the initial utterance generation unit 13 determines whether the scenario in the selected initial utterance information includes external information (step S13). If the initial utterance generation unit 13 determines that the scenario in the selected initial utterance information includes external information (step S13: YES), the initial utterance generation unit 13 acquires external information (step S14). Note that, if the initial utterance generation unit 13 determines that the scenario in the selected initial utterance information does not include any external information (step S13: NO), the initial utterance generation unit 13 skips the process in step S14.

Next, the initial utterance generation unit 13 generates utterance information (first utterance information) from the initial utterance information (step S15).

On the other hand, if the dialogue control unit 12 determines that the initial utterance condition is not satisfied (step S11: NO), the dialogue control unit 12 generates utterance information (second utterance information) from a dialogue model (step S16).

After step S15 or step S16, the dialogue control unit 12 controls the dialogue with the user (step S17). The dialogue history storage unit 18 then stores the history of dialogues with the user (step S18).

Furthermore, the dialogue device 10 starts a learning process at a timing that has been set as desired by the system administrator. Alternatively, the dialogue device 10 may start the learning process periodically at set timings, such as every Saturday, or may use the number of items of dialogue history information as a trigger, such as the first Saturday after 1,000 turns of dialogue history information are collected, for example. Note that the general-purpose dialogue generation unit 15 updates and uses the trained dialogue model 151 in the dialogue process described above.

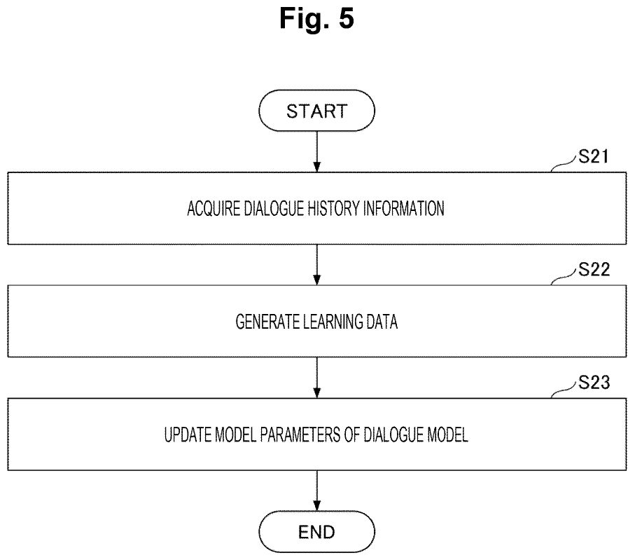

FIG. 5 is a flowchart illustrating an example flow of the learning process. The learning unit 16 acquires dialogue history information from the dialogue history storage unit 18 (step S21). Subsequently, the learning unit 16 generates training data (step S22). The learning unit 16 then updates the model parameters of the dialogue model 151, based on the training data (step S23).

FIG. 6 is a chart showing a specific example of a dialogue before learning. In the dialogue before learning, a dialogue is made along the scenario included in the initial utterance information, and, when the dialogue included in the scenario comes to an end, a general-purpose dialogue is made based on the dialogue model 151 before learning.

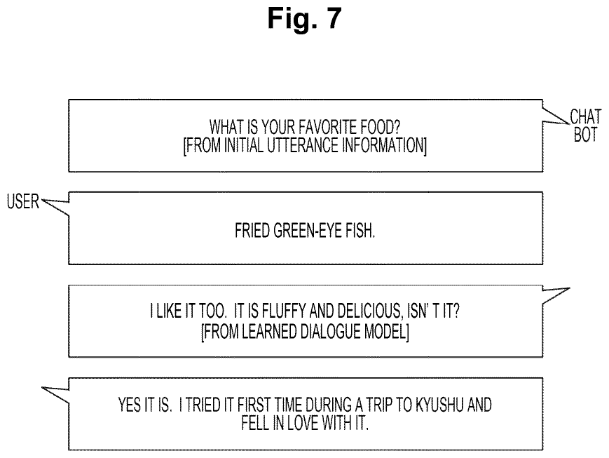

FIG. 7 is a chart showing a specific example of a dialogue after learning. In the dialogue after learning, a dialogue is started along the scenario included in the initial utterance information as in the dialogue before learning, but a dialogue close to the user's liking/preferences and the like is made, because of the learning based on the user's utterances. Thus, more personal utterances can be expected to be drawn from the user.

### (Example Hardware Configuration According to the Present Embodiment)

It is possible to implement the dialogue device 10 by causing a computer to execute a program in which the processing contents described in the present embodiment are written, for example. Note that the “computer” may be a physical machine, or may be a virtual machine in a cloud. In a case where a virtual machine is used, the “hardware” described herein is virtual hardware.

The above program can be stored and distributed, being recorded on a computer-readable recording medium (such as a portable memory). Alternatively, the above program can be provided through a network such as the Internet or electronic mail.

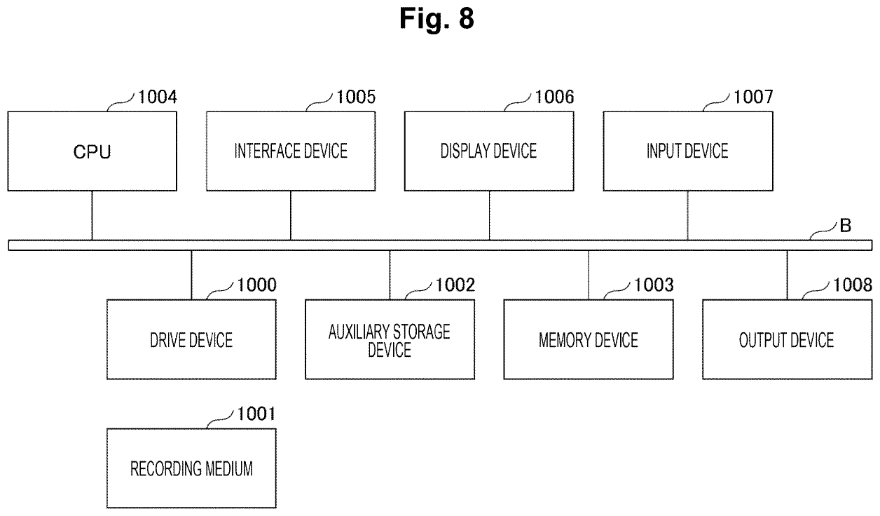

FIG. 8 is a diagram illustrating an example hardware configuration of the above computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for performing processes in the computer is provided through a recording medium 1001 such as a CD-ROM or a memory card, for example. When the recording medium 1001 storing the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is issued, the memory device 1003 reads the program from the auxiliary storage device 1002, and stores the program therein. The CPU 1004 implements functions related to the device according to the program stored in the memory device 1003. The interface device 1005 is used as an interface for connecting to a network. The display device 1006 displays a graphical user interface (GUI) or the like according to the program. The input device 1007 is configured with a keyboard and a mouse, buttons, a touch panel, or the like, and is used to input various operation instructions. The output device 1008 outputs computation results. Note that the computer may include a graphics processing unit (GPU) or a tensor processing unit (TPU) in place of the CPU 1004, and may include a GPU or a TPU in addition to the CPU 1004. In that case, processes may be shared and performed so that the GPU or the TPU performs the processes requiring special computation, and the CPU 1004 performs the other processes, for example.

### (Effects of the Present Embodiment)

With the dialogue device 10 according to the present embodiment, a dialogue with a user via a chat system is controlled based on a dialogue model and initial utterance information. The dialogue device then generates training data from a history of dialogues with the user, and updates model parameters of the dialogue model by machine learning. With this arrangement, the data for learning a response from a specific individual can be collected, and thus, it is possible to perform a dialogue specialized for the specific individual.

Further, as the user's utterances are learned through the training data, the dialogue model 151 is expected to generate utterances close to the user's liking, preferences, and the like, and turn into a dialogue model specialized for dialogues with the user.

Furthermore, as the machine learning of the dialogue model 151 is periodically performed, the dialogue model 151 gradually becomes capable of replying with a response closer to one from the user, and making a change in the dialogue (or digging deeper into the topic).

Chats based on a general-purpose dialogue model has a problem in that most of contents of dialogues are basically similar. With the dialogue device 10 according to the present embodiment, in addition to the general-purpose dialogue model, questions that may reveal the user's personality such as the user's preferences and opinions like “favorite things” and “news of interest” are set as scenarios, so that the dialogue device 10 can actively ask the user questions.

Further, the dialogue scheduler 11 starts a dialogue to ask the user a question at a fixed time on a daily basis. In this manner, training data can be continuously collected.

Furthermore, as the external information acquisition unit 14 acquires external information, it is possible to collect opinions and the like regarding information such as the latest news and the weather.

### Summary of the Embodiment

In the present specification, at least the dialogue device, the dialogue method, and the program described in the following items are described.

### (Item 1)

A dialogue device including:
an initial utterance generation unit that generates first utterance information serving as a trigger for a dialogue with a user;
a general-purpose dialogue generation unit that generates second utterance information; and
a dialogue control unit that controls the dialogue with the user, based on the first utterance information or the second utterance information.

### (Item 2)

The dialogue device according to Item 1, in which
the general-purpose dialogue generation unit generates the second utterance information, using a dialogue model,
the dialogue device further including: a learning unit that updates a model parameter of the dialogue model by machine learning using an utterance of the user as training data, based on a history of dialogues with the user.

### (Item 3)

The dialogue device according to Item 1 or 2, in which,
in an event that a predetermined initial utterance condition is satisfied, the dialogue control unit controls the dialogue with the user based on the first utterance information.

### (Item 4)

The dialogue device according to any one of Items 1 to 3, in which
the general-purpose dialogue generation unit generates the first utterance information, based on initial utterance information including a scenario of the dialogue, the initial utterance information being generated in advance.

### (Item 5)

The dialogue device according to Item 4, further including
an external information acquisition unit that acquires external information, in an event that the scenario selected from among the initial utterance information requires the external information.

### (Item 6)

The dialogue device according to any one of Items 1 to 5,
functioning as a chatbot in an online chat with the user.

### (Item 7)

A dialogue method executed by a dialogue device, the dialogue method including:
a step of generating first utterance information serving as a trigger for a dialogue with a user;
a step of generating second utterance information; and
a step of controlling the dialogue with the user, based on the first utterance information or the second utterance information.

### (Item 8)

A program for causing a computer to function as each component in the dialogue device according to any one of Items 1 to 6.

Although the present embodiment has been described so far, the present invention is not limited to such a specific embodiment, and various modifications and changes can be made within the scope of the present invention disclosed in the claims.

### REFERENCE SIGNS LIST

10 Dialogue device
11 Dialogue scheduler
12 Dialogue control unit
13 Initial utterance generation unit
14 External information acquisition unit
15 General-purpose dialogue generation unit
16 Learning unit
17 Dialogue API
18 Dialogue history storage unit
20 User terminal
30 Chat system
40 Communication network
131 Initial utterance information storage unit
151 Dialogue model
1000 Drive device
1001 Recording medium
1002 Auxiliary storage device
1003 Memory device
1004 CPU
1005 Interface device
1006 Display device
1007 Input device
1008 Output device

1. A dialogue device comprising:
a memory; and
a processor configured to:
generate first utterance information serving as a trigger for a dialogue with a user;
generate second utterance information; and
control the dialogue with the user, based on the first utterance information or the second utterance information.

2. The dialogue device according to claim 1, wherein the processor generates the second utterance information, using a dialogue model, and
the processor is further configured to update a model parameter of the dialogue model by machine learning using an utterance of the user as training data, based on a history of dialogues with the user.

3. The dialogue device according to claim 1, wherein, in an event that a predetermined initial utterance condition is satisfied, the processor controls the dialogue with the user based on the first utterance information.

4. The dialogue device according to claim 1, wherein the processor generates the first utterance information, based on initial utterance information including a scenario of the dialogue, the initial utterance information being generated in advance.

5. The dialogue device according to claim 4, wherein the processor is further configured to:
acquire external information, in an event that the scenario selected from among the initial utterance information requires the external information.

6. The dialogue device according to claim 1,
functioning as a chatbot in an online chat with the user.

7. A dialogue method executed by a dialogue device including a memory and a processor, the dialogue method comprising:
generating first utterance information serving as a trigger for a dialogue with a user;
generating second utterance information; and
controlling the dialogue with the user, based on the first utterance information or the second utterance information.

8. (canceled)

9. A non-transitory computer-readable recording medium having computer-readable instructions stored thereon, which, when executed, cause a computer to execute a method, the method comprising:
generating first utterance information serving as a trigger for a dialogue with a user,
generating second utterance information; and
controlling the dialogue with the user, based on the first utterance information or the second utterance information.
